(19) United States
(12) Patent Application Publication
(10) Pub. No.: US 2018/0025641 A1
(43) Pub. Date: Jan. 25, 2018

(54) PARKING DETECTION AND GUIDANCE SYSTEM

(71) Applicants: Alexander LaVelle, Hollywood, CA (US); Bryce Loop, Garden Grove, CA (US)

(72) Inventors: Alexander LaVelle, Hollywood, CA (US); Bryce Loop, Garden Grove, CA (US)

(21) Appl. No.: 15/217,693

(22) Filed: Jul. 22, 2016

(51) Int. Cl. G08G 1/14

(52) U.S. Cl. CPC G08G 1/143; G08G 1/144; H04B 10/11

(57) ABSTRACT

A real-time vehicle parking guidance system includes a plurality of wireless sensor nodes distributed in a parking area for detecting the presence of vehicles in parking spaces in the parking area, wherein the wireless sensor nodes transmit vehicle detection information through a hybrid communication method that uses optical wireless communication along with a backup radio frequency (RF) transmission; and a wireless hub communications unit including a programming element and a data module, for receiving the vehicle detection information from the wireless sensor nodes and transmitting the vehicle detection information to a processor for updating a corresponding display of the real-time vehicle parking on a computer or mobile device.

### FIELD OF THE INVENTION

The invention generally relates to the field of parking detection and guidance systems and more specifically, to a real-time parking detection and guidance system that uses wireless sensors with pulse detection and optical wireless communication capabilities.

### BACKGROUND OF THE INVENTION

In most large cities, it is becoming increasingly difficult to find available street or facility parking. Even when available parking spaces exist, visitors often have to circle around to search and find a parking space. This leads to a waste of the visitors' time, increased stress and frustration, and increased use of fuel and pollution. In commercial areas, the increased time spent looking for parking reduces the time consumers spend shopping, which reduces their revenues.

A parking guidance system provides visitors with information on where available parking spaces are located. However, past approaches to building such systems have various limitations. The currently available systems are not accurate in that they are not able to consistently detect the presence or absence of a vehicle in each parking space, as well as being prohibitively expensive and cumbersome to install. Systems that use wires or cables to sense the presence of vehicles in parking spaces can take a long time to install because they require an extensive wired infrastructure, which is very cumbersome to retrofit into existing parking.

Past approaches for detecting vehicles include the use of a variety of sensing methodologies including air hoses, ultrasonic sensors, and inductive loops. A disadvantage to these approaches is that they generally require extensive wiring to power the sensors and to collect the information that the sensors generate. Hence, parking guidance systems using these past sensing methodologies do not scale to large street parking demands and consequently, are not pervasively deployed today. Therefore, there is a need in the art for an improved parking detection and guidance system.

### BRIEF SUMMARY OF THE INVENTION

In an embodiment, a parking detection and guidance system tracks available parking spaces on a public street, and directs drivers to available parking spots through an internet web-based display on a computer or mobile device. Wireless sensor nodes can be deployed at parking spaces or within traffic lanes to monitor parking space occupancy through pulse detection. This information can be transmitted from each sensor through optical wireless communication. The sensors form a wireless network that routes the information of available parking spaces to a wireless hub communications unit, which transmits this information to a server or processor for updating the corresponding display. Parking availability information can also be shared with users in a variety of other ways such as through the personal digital assistants, in-vehicle dashboards, and others.

In an embodiment, the design and development of sensor node hardware for pulse detection and optical wireless communication is affordable, energy efficient, produces accurate readings, is customer friendly, and scalable. The hardware is robust, easy to install, and can be camouflaged within the infrastructure of a parking space on a public street. The invention provides quick and accurate updates to the internet web-based display to direct traffic towards available parking spots. The embedded software improves the battery life of the sensor node hardware, as well as the reliability and response time of the system. This system can help remove traffic congestion caused by drivers searching for available parking spots.

In an embodiment, the parking detection and guidance system is scalable to meet the needs of networks containing thousands of sensor nodes, each corresponding to a parking space. The system of the current invention has numerous advantages: it is easy to deploy, self-configurable, and low maintenance.

Further, the system provides for enforcement of parking policies, as well as allowing the consumer to pay for parking remotely via a computer or their mobile device. In addition, the system is designed based on a scalable and modular architecture that can be easily customized to the varying requirements of different types and sizes of parking and street designs.

In addition, the system provides for a payment system for drivers to pay for street parking remotely removing the need for parking meters. For example, digital pay stations accessed via an internet web-based or mobile device can be used for drivers to pay for parking remotely.

In an embodiment, the parking detection and guidance system can be used with indoor or outdoor parking, or combinations of these two. The technology is resistant to external factors such as weather conditions. The system uses a hybrid communication method that uses optical wireless communication along with a backup radio frequency (RF) transmission, which can be deployed in open infrastructures where it is impossible to install wires or lack power sources. The system provides accurate estimates of the available parking spaces and generates comprehensive reports of real-time and historical parking activities.

In an embodiment, the disclosure provides a real-time vehicle parking guidance system, which includes: a plurality of wireless sensor nodes distributed in a parking area for detecting the presence of vehicles in parking spaces in the parking area, wherein the wireless sensor nodes transmit vehicle detection information through a hybrid communication method that uses optical wireless communication along with a backup radio frequency (RF) transmission; and a wireless hub communications unit including a programming element and a data module, for receiving the vehicle detection information from the wireless sensor nodes and transmitting the vehicle detection information to a processor for updating a corresponding display of the real-time vehicle parking on a computer or mobile device.

In one aspect, the disclosure provides a real-time vehicle parking guidance system wherein the plurality of wireless sensor nodes use pulse induction technology for detecting the presence of vehicles.

In another aspect, the disclosure provides a real-time vehicle parking guidance system wherein the plurality of wireless sensor nodes use a programmed timing profile to turn on the sensor nodes more frequently during peak parking hours and less frequently during off peak parking hours.

In another aspect, the disclosure provides a real-time vehicle parking guidance system wherein the wireless hub communications unit transmits the vehicle detection information to the processor using a machine to machine connection, e.g. a 3G M2M connection.

In another aspect, the disclosure provides a real-time vehicle parking guidance system wherein the plurality of wireless sensor nodes are arranged to provide two-way communication between emitters and receivers of the sensor nodes.

In another aspect, the disclosure provides a real-time vehicle parking guidance system wherein the plurality of wireless sensor nodes are arranged in a point to point (line) topology using optical wireless communication multihopping between the sensor nodes for communication between the sensor nodes and the wireless hub communications unit.

In another aspect, the disclosure provides a real-time vehicle parking guidance system wherein light emitting diode (LED), or similar light emitting component, arrays in each of the plurality of wireless sensor nodes passes data between each sensor node using optical wireless communication.

In another aspect, the disclosure provides a real-time vehicle parking guidance system wherein the optical wireless communication transmits vehicle detection information faster than the RF transmission.

In another aspect, the disclosure provides a real-time vehicle parking guidance system wherein there is one wireless sensor node for each parking space.

In another aspect, the disclosure provides a real-time vehicle parking guidance system wherein the parking area is a parking area of a parking lot, a parking structure, or a street parking.

In another embodiment, the disclosure provides a method of providing real-time vehicle parking guidance, which includes: detecting whether a vehicle is present in a parking space in a parking area using a wireless sensor node; transmitting the vehicle detection information from the wireless sensor node to a wireless hub communications unit through a hybrid communication method that uses optical wireless communication along with a backup radio frequency (RF) transmission in case of obstacles or debris, wherein the wireless hub communications unit includes a programming element and a data module; and transmitting the vehicle detection information from the wireless hub communications unit to a processor for updating a corresponding display of the real-time vehicle parking on a computer or mobile device.

In one aspect, the disclosure provides a method of providing real-time vehicle parking guidance, wherein the wireless sensor node uses pulse induction technology for detecting the presence of a vehicle.

In another aspect, the disclosure provides a method of providing real-time vehicle parking guidance, wherein the wireless sensor node uses a programmed timing profile to turn on the sensor node more frequently during peak parking hours and less frequently during off peak parking hours.

In another aspect, the disclosure provides a method of providing real-time vehicle parking guidance, wherein the wireless hub communications unit transmits the vehicle detection information to the processor using a machine to machine connection, e.g. 3G M2M connection.

In another aspect, the disclosure provides a method of providing real-time vehicle parking guidance, wherein the wireless sensor node is arranged to provide two-way communication between emitters and receivers of other wireless sensor nodes.

In another aspect, the disclosure provides a method of providing real-time vehicle parking guidance, wherein the wireless sensor nodes are arranged in a point to point (line) topology using optical wireless communication multihopping between the sensor nodes for communication between the sensor nodes and the wireless hub communications unit.

In another aspect, the disclosure provides a method of providing real-time vehicle parking guidance, wherein light emitting diode (LED) arrays, or similar light emitting component, in each of the wireless sensor nodes passes data between each sensor node using optical wireless communication.

In another aspect, the disclosure provides a method of providing real-time vehicle parking guidance, wherein the optical wireless communication transmits detection information faster than the RF transmission.

In another aspect, the disclosure provides a method of providing real-time vehicle parking guidance, wherein there is one wireless sensor node for each parking space.

In another aspect, the disclosure provides a method of providing real-time vehicle parking guidance, wherein the parking area is a parking area of a parking lot, a parking structure, or a street parking.

Other objects, features, and advantages of the present invention will become apparent upon consideration of the following detailed description and the accompanying drawings, in which like reference designations represent like features throughout the figures.

### BRIEF DESCRIPTION OF THE DRAWINGS

FIG. 1 illustrates an embodiment of a parking detection and guidance system;

FIG. 2 illustrates an embodiment of the wireless sensor nodes that uses optical wireless communication along with a backup radio frequency (RF) transmission in case of obstacles or debris, for communication with the wireless hub communications unit; and

FIG. 3 illustrates an embodiment of a point to point (line) topology using optical wireless communication multihopping between nodes for communication between the nodes and the wireless hub communications unit.

### DETAILED DESCRIPTION OF THE INVENTION

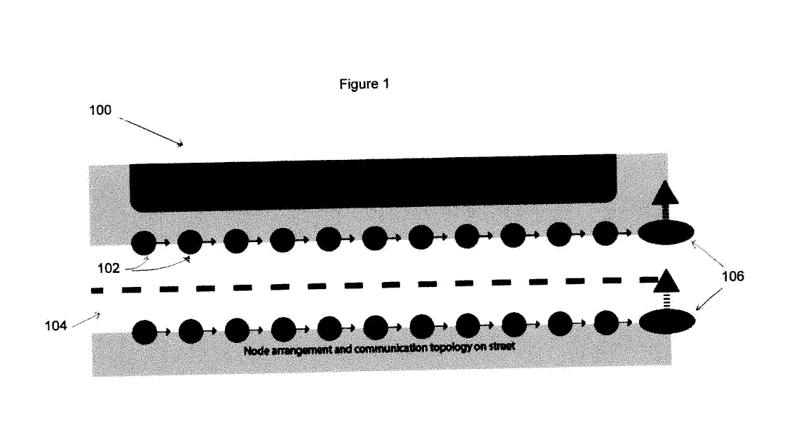

FIG. 1 illustrates an embodiment of a parking detection and guidance system (100). The system includes a plurality of wireless sensor nodes (102) on, for example, a public street (104). Each of these sensors include several components, for example, a sensing element; a programming element; a timing profile; a battery; and a sensor case.

Functionally, the plurality of wireless sensor nodes (102) forms a wireless sensor node network, which includes multiple entities that communicate with each other. The sensors receive and transmit parking information to a wireless hub communications unit (106) via a hybrid communication method that uses optical wireless communication (OWC) along with a backup radio frequency (RF) transmission in order to generate real time parking availability data. The wireless hub communications unit transmits this information to one or more servers, which processes and delivers the available parking information to a corresponding internet web-based display on a computer or mobile device.

The sensing element of a wireless sensor uses pulse induction technology to send powerful, short bursts (pulses) of current through a coil of wire. Each pulse generates a brief magnetic field. When the pulse ends, the magnetic field reverses polarity and collapses very suddenly, resulting in a sharp electrical spike. This spike lasts about a few microseconds (millionths of a second) and causes another current to run through the coil. This current is known as the “reflected pulse” and is also extremely short, lasting only about 30 microseconds. If a metal object is over a sensor, the pulse creates an opposite magnetic field in the object. When the pulse's magnetic field collapses, causing the reflected pulse, the magnetic field of the object makes it take longer for the reflected pulse to completely disappear. This induction allows the sensor to be vastly more reliable and accurate than any other type of sensor. Objects that are non-metallic and which are not vehicle sized in nature are invisible to the sensor. This also allows the wireless sensor nodes to operate without interference from weather or debris.

The programming element and timing profile of the sensor includes a microprocessor chip that stores and executes the appropriate code. As opposed to detecting constantly, the detection process uses a programmed “timing profile.” Typically, the average duration of a parked car's stay far exceeds the need for a real time sensor. To reflect this, a timing profile has been developed for specific locations: a sensor can wake up, run the detection process, and turn off. The processor is programmed to wake up the sensors more frequently during peak hours and less frequently during off peak hours, thereby increasing the lifespan of the sensors.

A longer battery lifespan can be accomplished by the combination of primary lithium cells and the unique “timing profile” method, which allows for a low level of power consumption. Typically, the sensors last more than 4 years with a minimal battery supply.

In practice, the sensors have to withstand impact from moving vehicles, sustained loads from parked vehicles, temperatures ranging from −40° F. to 120° F., direct sunlight for 12 or more hours at a time, dust, rain, snow, sleet, and vibration. To address these criteria, an epoxy resin sensor case can be used to encompass the sensor and its components, which is capable of supporting a 20,000 pound load and is impervious to any and all weather conditions. The sensor and its components can be entirely sealed for the life of the unit.

The wireless hub communications unit (“internet node, Tier 2”) is a communications collector, taking in data from the sensors and using a machine to machine connection to pass the data to servers. The wireless hub communications unit is approximately twice the size of the sensor and can be mounted on the street surface.

The wireless hub communications unit includes several components: a programming element; a data module; and a hub case. The programming element includes microprocessor and transceiver elements that are carried over from sensor unit. The data module uses, for example, an AT&T machine to machine communications module to send data collected from the sensors to a server. The hub case encompasses these components, and can withstand impact from vehicles, sustained loads from parked vehicles, temperatures from −40° F. to 120° F., direct sunlight for 12+ hours at a time, dust, rain, snow, sleet, and vibration. To meet these criteria, the hub case is made of an epoxy resin, which is capable of supporting 20,000 lb loads and is impervious to any and all weather conditions. The wireless hub communications unit is entirely sealed for the life of the unit. The geometry and structure of the unit is designed and tested to withstand these loads.

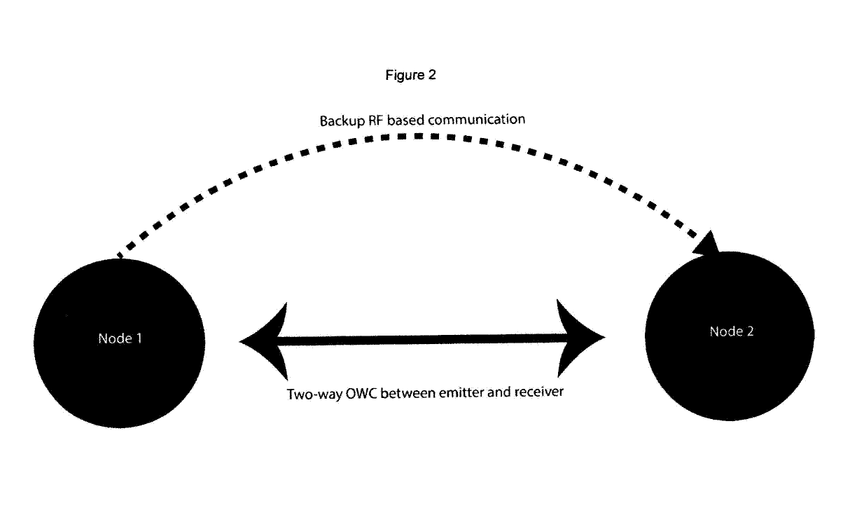

As shown in FIG. 2, wireless sensors nodes 1 and 2 use a hybrid communication method that uses optical wireless communication (OWC) along with a backup radio frequency (RF) transmission for communication with the wireless hub communications unit. In addition, the wireless sensor nodes 1 and 2 can be arranged to provide two-way communication between the emitters and receivers of the nodes. A light emitting diode (LED) array, or similar light emitting component, in each sensor passes data between each node using optical wireless communication. The use of optical wireless communication as a primary communication method has two major benefits: first, it allows for improved efficiency via reduced power consumption; and second, it allows for substantially higher data transfer rates. LED's consume less power than conventional RF modules and thus, reduce the energy required to transmit data. In an embodiment, the RF module supports an RF range up to 100 feet. In other embodiments, the RF range may be greater than 100 feet. A conventional RF module appropriate for this design is approximately 0.25 Mb/s while the optical wireless communication process can approach 30 Mb/s or more. Combining faster data transfer and reduced power consumption leads to a better product.

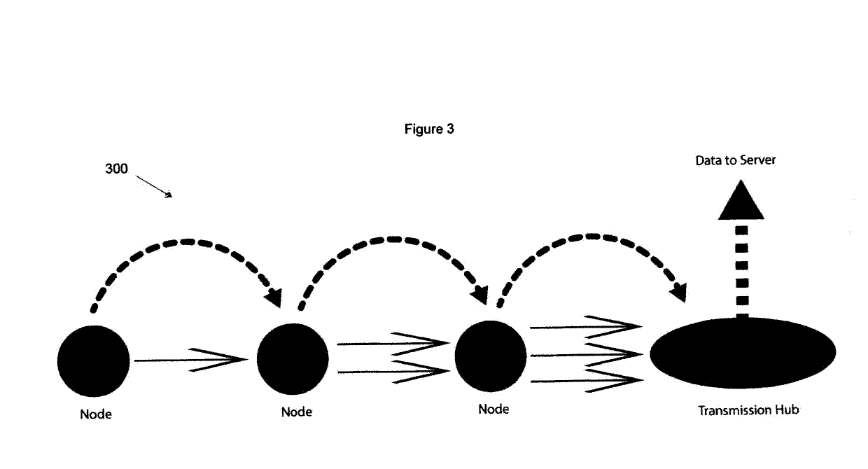

As shown in FIG. 3, a point to point (line) topology using optical wireless communication multihopping between nodes (302) can be used for communication between the nodes and the wireless hub communications unit (304). Due to the line of sight requirement for optical wireless communication, RF (dashed lines) can be used as a backup to circumvent any potential obstruction in the path. Once transmitted to the wireless hub communications unit, the data can be transferred to a server for processing.

Optical wireless communication works by encoding the data in a similar method to RF transfer but pulses a light source millions of times per second to a receiving sensor. The receiving sensor, and accompanying processor, decode these pulses into the binary uses to reform the original data.

There are several advantages of this topology over alternatives on this scale. First, it allows for building a unique string of sensors. This creates an extremely modular system allowing robust implementation on a global scale. The modular approach allows for tailoring a specific timing profile to meet the needs of a particular street, a strong advantage over any other system. Second, there are limitations on the robustness of a mesh network when faced with road construction. A localized modular line network is much more robust when faced with a dynamic environment with routine road construction. The optical wireless communication approach allows each street to operate independently of the others. Damage or construction on one street allows the system to maintain functionality to maximize uptime.

To reduce power consumption and inefficiency, the above mentioned “timing profile” has been designed. The timing profile is a programming element that describes how frequently and at what times a sensor activates. This program can be customized based on the needs of the application: a street with a strong nightlife presence and minimal morning usage can receive a timing profile with very frequent sensor activations in the evening but reduced activations in the morning to avoid wasting battery when finding parking isn't as much of a problem. This unique profile can be modified for any street environment to maximize performance while minimizing power consumption.

Aside from detecting the occupancy of each parking space, the system can also count the number of vehicles entering or leaving a specific street parking area, in order to determine the number of available parking spaces in that area.

In addition to using a specific sensor node to track one or more parking spaces, the system can also leverage one or more sensor nodes in a collaborative fashion to determine the availability of a set of parking spaces. Information from the different sensor nodes can be processed in a distributed fashion to reinforce observations as well as eliminate false negative or false positive observations.

The wireless hub communications unit is responsible for handling the continuous data stream generated by sensor nodes, and forwarding that information to a server for processing. The server can determine the parking guidance information within each direction on a street.

The use of optical wireless communication saves significant costs that would otherwise arise from laying communication cables. Moreover, the use of optical wireless communication rapidly facilitates the deployment of the application to parking facilities of varying structure and scale. For instance, the system may be deployed in indoor or outdoor parking facilities, incline ramps, multilevel facilities, basement facilities, or street parking.

The server processes the information for presenting parking guidance information to end users via an internet web-based display on a computer or mobile device. Depending on the capability of the displays, appropriate alphanumeric messages and symbols can be flashed on the display screen to guide the visitor to the closest available spot. For example, a display may simply show the count of available spaces, and if all spaces are occupied, the display may flash the sign “FULL.” The displays may include dynamic signage as well as user friendly navigation facilities to visitors.

The displays may also be manually controlled via a server to present other custom information. For example, while some displays may show parking availability information, other displays may be manually overridden to show advertising messages, public safety messages, special event messages, or other information. Each display may be easily configured via an intuitive web browser based interface, thus reducing the manual labor associated with parking zone control. This feature may also be leveraged to indicate fixed routes, special reservations, or parking area closures for maintenance work. For example, traffic control inspectors can streamline heavy traffic flow with the appropriate messages flashed on the displays.

The description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

What is claimed is:

1. A real-time vehicle parking guidance system, comprising:
a plurality of wireless sensor nodes distributed in a parking area for detecting the presence of vehicles in parking spaces in the parking area, wherein the wireless sensor nodes transmit vehicle detection information through a hybrid communications method that uses optical wireless communication (OWC) along with a backup radio frequency (RF) transmission; and
a wireless hub communications unit including a programming element and a data module, for receiving the vehicle detection information from the wireless sensor nodes and transmitting the vehicle detection information to a processor for updating a corresponding display of the real-time vehicle parking on a computer or mobile device.

2. The real-time vehicle parking guidance system of claim 1, wherein the plurality of wireless sensor nodes use pulse induction technology for detecting the presence of vehicles.

3. The real-time vehicle parking guidance system of claim 1, wherein the plurality of wireless sensor nodes use a programmed timing profile to turn on the sensor nodes more frequently during peak parking hours and less frequently during off peak parking hours.

4. The real-time vehicle parking guidance system of claim 1, wherein the wireless hub communications unit transmits the vehicle detection information to the processor using a machine to machine connection.

5. The real-time vehicle parking guidance system of claim 1, wherein the plurality of wireless sensor nodes are arranged to provide two-way communication between emitters and receivers of the sensor nodes.

6. The real-time vehicle parking guidance system of claim 5, wherein the plurality of wireless sensor nodes are arranged in a point to point (line) topology using optical wireless communication multihopping between the sensor nodes for communication between the sensor nodes and the wireless hub communications unit.

7. The real-time vehicle parking guidance system of claim 1, wherein a light emitting diode (LED) array, or similar light emitting component, in each of the plurality of wireless sensor nodes passes data between each sensor node using optical wireless communication.

8. The real-time vehicle parking guidance system of claim 6, wherein the optical wireless communication transmits vehicle detection information faster and/or more efficiently than the RF transmission.

9. The real-time vehicle parking guidance system of claim 1, wherein there is one or more wireless sensor node for each parking space.

10. The real-time vehicle parking guidance system of claim 1, wherein the parking area is a parking area of a parking lot, a parking structure, or a street parking.

11. A method of providing real-time vehicle parking guidance, comprising:
detecting whether a vehicle is present in a parking space in a parking area using a wireless sensor node;
transmitting the vehicle detection information from the wireless sensor node to a wireless hub communications unit through a hybrid communication method that uses optical wireless communication (OWC) along with a backup radio frequency (RF) transmission, wherein the wireless hub communications unit includes a programming element and a data module; and
transmitting the vehicle detection information from the wireless hub communications unit to a processor for updating a corresponding display of the real-time vehicle parking on a computer or mobile device.

12. The method of providing real-time vehicle parking guidance of claim 11, wherein the wireless sensor node uses pulse induction technology for detecting the presence of a vehicle.

13. The method of providing real-time vehicle parking guidance of claim 11, wherein the wireless sensor node uses a programmed timing profile to turn on the sensor node more frequently during peak parking hours and less frequently during off peak parking hours.

14. The method of providing real-time vehicle parking guidance of claim 11, wherein the wireless hub communications unit transmits the vehicle detection information to the processor using a machine to machine connection.

15. The method of providing real-time vehicle parking guidance of claim 11, wherein the wireless sensor node is arranged to provide two-way communication between emitters and receivers of other wireless sensor nodes.

16. The method of providing real-time vehicle parking guidance of claim 15, wherein the wireless sensor nodes are arranged in a point to point (line) topology using optical wireless communication multihopping between the sensor nodes for communication between the sensor nodes and the wireless hub communications unit.

17. The method of providing real-time vehicle parking guidance of claim 16, wherein a light emitting diode (LED) array, or similar light emitting component, in each of the wireless sensor nodes passes data between each sensor node using optical wireless communication.

18. The method of providing real-time vehicle parking guidance of claim 16, wherein the optical wireless communication transmits detection information faster than the RF transmission.

19. The method of providing real-time vehicle parking guidance of claim 11, wherein there is one or more wireless sensor node for each parking space.

20. The method of providing real-time vehicle parking guidance of claim 11, wherein the parking area is a parking area of a parking lot, a parking structure, or a street parking.
